(19) United States
(12) Patent Application Publication
(10) Pub. No.: US 2026/0302223 A1
(43) Pub. Date: Oct. 1, 2026

(54) A COMPOSITE CATHODE MATERIAL OF POLYANION AND LAYERED OXIDE FOR SODIUM-ION BATTERY AND METHOD OF SYNTHESIZING THEREOF

(71) Applicant: NATIONAL UNIVERSITY OF SINGAPORE, Singapore (SG)

(72) Inventors: Balaya PALANI, Singapore (SG); Aniruddh RAMESH, Singapore (SG); Chen WANG, Singapore (SG)

(73) Assignee: NATIONAL UNIVERSITY OF SINGAPORE, Singapore (SG)

(21) Appl. No.: 19/477,869

(22) PCT Filed: Apr. 23, 2024
(86) PCT No.: PCT/SG2024/050264

§ 371 Date: Oct. 23, 2025

(30) Foreign Application Priority Data
Apr. 24, 2023 (SG) 10202301142Y

(51) Int. Cl. H01M 4/58; H01M 4/02; H01M 4/36; H01M 4/66; H01M 4/75; H01M 10/054

(52) U.S. Cl. CPC H01M 4/5825; H01M 4/366; H01M 4/661; H01M 4/75; H01M 10/054; H01M 2004/028

(57) ABSTRACT

Disclosed is polyanion-layered oxide composite cathode material for a sodium battery or sodium-ion battery, the material comprising a polyanion and a layered oxide, wherein the polyanion is Na3V2(PO4)3 (NVP) or Na4VMn(PO4)3 (NVMP); wherein the layered oxide is selected from the group consisting of O3/P3-NaxMyOz, O3/P2-NaxMyOz, O3-NaxMyOz, P2-NaxMyOz, and P3-NaxMyOz; and wherein x is ≥0.9, 0.8≤y≤1.0, and z is ≤2. The NVP can be Zn doped NVP. Also disclosed is a method of synthesizing the polyanion-layered oxide composite cathode material as disclosed herein. Further disclosed is a sodium battery or sodium ion battery comprising the polyanion-layered oxide composite cathode material as disclosed herein.

### FIELD OF THE INVENTION

The present invention generally relates to a composite cathode material for a sodium battery or sodium-ion battery, and a method of synthesizing thereof. In particular, the present invention relates to a polyanion-layered oxide composite cathode material for a sodium battery or sodium-ion battery, and a method of synthesizing thereof.

### BACKGROUND

Transitioning towards a low carbon footprint economy demands advanced energy storage and conversion technologies such as batteries. Conventionally, lithium-ion battery is the most popular kind of rechargeable storage system as they have high energy density. However, concerns about the shortage of lithium reserves and higher costs have grown and sodium-ion batteries seem to be a potential replacement candidate as there are more sodium reserves available. Additionally, sodium-ion batteries (NIB) are considered safer than their lithium counterparts. By shipping such cells in the shorted state, this could potentially get rid of risks associated with transportation, which is an issue with lithium-ion cells. Besides grid applications, the sodium battery technology can be extended to the transportation sector as well, if the energy density could be improved.

Sodium-ion layered oxides offer the highest theoretical capacities due to their lower molecular weights as compared to other families of sodium-ion cathode materials such as polyanion or Prussian Blue Analogues. Conventionally, these sodium-ion layered oxides are classified as O3, P3, P2 and O2 types depending upon the co-ordination of Na-ions in the crystal structure [10]. Although many layered oxides can provide high capacity due to their small molecular weight, their further application is hindered by low output voltage, irreversible phase transition, low storage instability, poor rate performance and cycle life. In addition, for layered oxide, the evolution of oxygen can lead to thermal runaway problems due to undesirable side reactions with the electrolyte at high voltages. Comparatively, polyanion materials exhibit higher operating potentials due to the inductive effect of polyanion groups. Their robust 3D framework significantly decreases the structural variations during sodium ion de/intercalation. Moreover, the effect of strong X—O (X═S, P, Si, etc.) covalent bonds can effectively inhibit oxygen evolution. These advantages contribute to the superior cycle stability and thermal stability of polyanion compared to the layered oxides, especially at high voltages. However, further application of polyanion material is usually hindered by its low electronic conductivity, limited capacity and low tap densities.

Thus, there is a need for a novel cathode material for a sodium battery or sodium-ion battery, which avoids the disadvantages of, but gleans the benefits of both polyanion as well as layered oxide compounds. In other words, there is a need for a novel cathode material for a sodium battery or sodium-ion battery which does not exhibit the low tap densities of polyanionic compounds and the low thermal stability of layered oxides. In this invention, a polyanion-layered oxide composite positive electrode material for a sodium battery or sodium-ion battery is developed. The composite cathode material exhibits high levels of thermal stability and superior electrochemical performances within selected optimized voltage windows in both half-cell and commercial type full cells.

### SUMMARY

The present disclosure describes a polyanion-layered oxide composite cathode material for a sodium battery or sodium-ion battery, and a method of synthesizing thereof.

In one aspect, the present disclosure refers to a polyanion-layered oxide composite cathode material for a sodium battery or sodium-ion battery, the material comprising a polyanion and a layered oxide, wherein the polyanion is Na₃V₂(PO₄)₃ (NVP) or Na₄VMn(PO₄)₃ (NVMP); wherein the layered oxide is selected from the group consisting of O3/P3-NaₓM_{y}O_{z}, O3/P2-NaₓM_{y}O_{z}, O3-NaₓM_{y}O_{z}, P2-NaₓM_{y}O_{z}, and P3-NaₓM_{y}O_{z}; and wherein x is ≥0.9, 0.8≤y≤1.0, and z is ≤2.

In another aspect, the present disclosure refers to a method of synthesizing the polyanion-layered oxide composite cathode material as disclosed herein, wherein the method comprises any one of the following steps:
a) mixing a polyanion powder and a layered oxide powder to obtain a mixture, and coating the mixture on an Al foil; or
b) coating a layer of polyanion on an Al foil, then coating a layer of layered oxide on top of the polyanion layer; or
c) coating a layer of layered oxide on an Al foil, then coating a layer of polyanion on top of the layered oxide layer; or
d) coating polyanion and layered oxide in an alternating pattern on an Al foil; wherein in any of a)-d), the coating is done on both sides of the Al foil for a thickness of 50-250 μm.

In another aspect, the present disclosure refers to a sodium battery or sodium-ion battery comprising the polyanion-layered oxide composite cathode material as disclosed herein.

These are the first set of composite cathode materials known for a sodium battery or sodium-ion battery. Advantageously, the poly anion-layered oxide composite cathode materials demonstrate energy densities in the range of 300-800 Wh/kg_{cathode} in optimized voltage windows. They also demonstrate exceptional rate performance. In addition, the composite cathode materials are shown to exhibit more thermal stability at higher temperatures and hence improved safety aspects when compared to layered oxide cathodes. Also, tap densities of the composite are significantly enhanced when compared to polyanion compounds.

Advantageously, the synthesis process to produce the polyanion-layered oxide composite cathode material is simple and inexpensive.

### BRIEF DESCRIPTION OF THE DRAWINGS

The invention will be better understood with reference to the detailed description when considered in conjunction with the non-limiting examples and the accompanying drawings, in which:

FIG. 1 illustrates the O and P Structures of a sodium-ion layered oxide, as proposed by Delmas et, al. [10].

FIG. 2 illustrates the structure of a Na-ion polyanion Na₃V₂(PO₄)₃ (NVP).

FIG. 3 are schematic drawings showing four methods of preparing the polyanion-layered oxide composite electrode coating.

FIG. 4 are XRD plots of NVP, NVMP and different types of oxides.

FIG. 5 are graphs showing cycling performances of (a) O3 Oxide at 0.02 Ag⁻¹ (C/5); (b) P3 Oxide at 0.015 Ag⁻¹ (C/10); (c) O3/P3 Oxide at 0.015 Ag⁻¹ (C/10); (d) NVP at 0.024 Ag⁻¹. Tap density for NVP is shown.

FIG. 6 are graphs showing (a), (b) and (c) different composites of P2 layered oxides and NVP cycled at C/10 (0.012 A g⁻¹); (d) Composite of O3 layered oxides and NVP cycled at C/10 (0.012 A g⁻¹). Tap density values are shown.

FIG. 7 are graphs showing the following: (a) and (b) 30% biphasic oxide and 70% NVP cycled at C/10 (0.015 A g⁻¹) showing an excellent capacity retention of 94% after 100 cycles; (c) Rate performance of 30% biphasic oxide and 70% NVP; (d) 30% biphasic oxide and 70% NVP showing capacity retention of 90% after 500 cycles when cycled at 1 C (0.15 A g 1). Tap density of composite is shown.

FIG. 8 are graphs showing composites of O3 layered oxides and NVP cycled at C/10 (0.01 A g⁻¹) in 18650 commercial cell.

FIG. 9 are EIS plots: (a) EIS plot of 100% O3/P3 oxide; (b) EIS plot of composite 30% biphasic O3/P3 oxide and 70% NVP showing significantly lower internal resistance.

FIG. 10 are DSC plots of (a) 100% O3/P3 oxide; (b) 70% O3/P3 oxide and 30% NVP; (c) 30% O3/P3 oxide and 70% NVP, which is the most thermally stable.

FIG. 11 shows comparison of storage capacity of Zn-doped NVP against pristine NVP. As shown are voltage profiles of (a) pristine NVP and (b) modified NVP cycled at C/10.

FIG. 12 (a) shows comparison of rate performance of Zn-doped NVP against pristine NVP. As shown are voltage profiles of rate performances of both the pristine NVP and modified NVP. (b) shows comparison of impedance data of Zn-doped NVP against pristine NVP. As shown are EIS Nyquist plots of pristine NVP and modified NVP, with inset showing the equivalent circuit model used for data fitting.

FIG. 13 shows comparison of storage performance and rate performance 18650 cells made using pristine NVP and Zn doped NVP. As shown are voltage profiles at C/7 and rate performance of (a) pristine NVP vs. HC and (b) modified NVP vs. HC in 18650 format cycled between 1.0 and 4.1 V. Inset to (a) and (b) depicts the respective fabricated 18650 cell.

FIG. 14 shows rate performance of 18650 cells fabricated using pristine and Zn-doped NVP. As shown are voltage profiles at C/7 and rate performance of (a) pristine NVP vs. HC and (b) modified NVP vs. HC in 18650 format cycled between 1.0 and 4.1 V.

FIG. 15 shows the voltage profile of modified NVP cycled at C/10 with a lower active material loading of 3-4 mg cm 2.

### DETAILED DESCRIPTION

The present disclosure describes a polyanion-layered oxide composite cathode material for a sodium battery or sodium-ion battery, as well as a simple synthesis process to produce this material.

In one aspect, the present disclosure refers to a polyanion-layered oxide composite cathode material for a sodium battery or sodium-ion battery, the material comprising a polyanion and a layered oxide, wherein the polyanion is Na₃V₂(PO₄)₃ (NVP) or Na₄VMn(PO₄)₃ (NVMP); wherein the layered oxide is selected from the group consisting of O3/P3-NaₓM_{y}O_{z}, O3/P2-NaₓM_{y}O_{z}, O3-NaₓM_{y}O_{z}, P2-NaₓM_{y}O_{z}, and P3-NaₓM_{y}O_{z}; and wherein x is ≥0.9, 0.8≤y≤1.0, and z is ≤2.

Sodium-ion batteries are the most promising alternatives to the lithium counterparts as they offer lower cost. Benefiting from the high abundance and low cost of sodium resource, sodium-ion batteries serve as a very promising electrochemistry technology for energy storage. There is a need for the development of high-performance and stable cathode materials for sodium batteries and sodium-ion batteries.

The present invention discloses a composite cathode material comprising a polyanion and a layered oxide. A polyanion provides several advantages as a cathode material for batteries, including high thermal stabilities, improved oxidative stability at high voltages and flat voltage response.

As used herein, the term “cycling” refers to a complete charging and discharging cycling process. Charging refers to a process for providing electrochemical energy to a cell, and discharging refers to a process for removing electrochemical energy from a cell.

As used herein, the term “cathode” refers to an electrode (often called the positive electrode) where electrochemical reduction and sodiation occurs during a discharging process.

By definition, a polyanion-type material is a type of compound that contains a series of tetrahedral anionic units (XO₄)ⁿ⁻ or their derivatives (XₘO₃ₘ₊₁)ⁿ⁻ (X═S, P, Si, As, Mo, or W) connected with strong covalent-bonded MOₓ polyhedra (M represents a transition metal). In most of the polyanions, the polyanionic unit not only allows for fast ion conduction within the open framework, but also stabilizes the operative redox potentials of the comprised transition metals. Such a connection results in a high structural stability upon sodium ion insertion and extraction. Compared to layered oxides, the strong X—O bonding in polyanion-type compounds can introduce ionicity in M-O bonding and the weaker ionic bonding in M-O increases the distance between its antibonding orbitals vis-à-vis the A/A+ redox couple, leading to a higher redox potential. This is the “inductive effect” in polyanion-type electrode materials. Furthermore, the strong X—O covalent bonds greatly improve the stability of O in the lattice, thus increasing the safety of such materials, which make them very appealing for application in rechargeable batteries.

In one example, the polyanion comprises a single polyanion group, such as (SO₄)²⁻ (PO₄)³⁻, (P₂O₇)⁴⁻, and (SiO₄)⁴⁻. A rather concise structure, AₓM(XO₄), has been widely used and shown good performance in batteries. More complex structures, including different polyanionic groups and different transition metal redox centers generally allow for tuning and further optimization of the electrochemical properties.

In another example, the polyanion comprises mixed polyanion groups. The mixed polyanion concept comes from the idea of tuning the redox couples in sodium (Na) Super Ionic CONductor (NASICON) structured materials by anionic substitution. More recently theoretical studies predicted that the combination of YO₃^{2 or 3-} and XO₄^{3 or 4-} (Y═C, B; X═Si, As, P) could give a series of new AₓM(YO₃)(XO₄) compounds (A=Na; M=a redox transition metal; and x 0-3) suitable for use as cathode materials. The existence of a continuous, wide compositional domain in a mixed-polyanion system will significantly enrich material design strategies and contribute to the development of new cathode materials for sodium batteries and sodium ion batteries.

In another example, the polyanion is a phosphate polyanion. Phosphate polyanions have the following advantages: (i) high structural stability due to the very stable P—O bond, ensuring long-term cycling, enhanced safety content, and reduced likelihood of oxygen release from the structure; (ii) many (and rather large) interstitial sites of the 3D framework leading to lower volumetric expansion during Na ion insertion/extraction and contributing to structural stability; (iii) an inductive effect of phosphate on the redox couple, enabling higher redox potential values vs. Na/Na+. Examples include phosphates, pyrophosphates, mixed anions, and materials with various redox centers (Fe, V, Mn, Ni, Co. et al.). Diverse phosphate-based polyanionic frameworks can be realized by (i) edge/coiner sharing coordination of simple PO₄³⁻ units, (ii) multiple PO₄³⁻ units forming metaphosphates and pyrophosphates, (iii) the combination of mixed poly anions (e.g., PO₄—P₂O₇) and (iv) the combination of PO₄³⁻ units with other anions (e.g., F⁻, OH⁻, N³⁻).

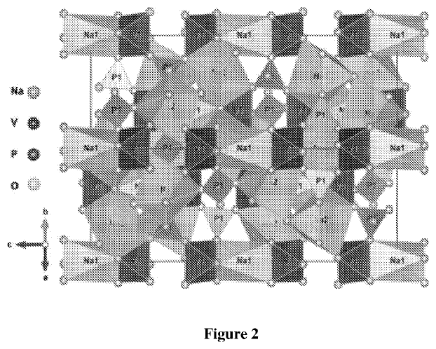

In one example, the polyanion is sodium vanadium phosphate, Na₃V₂(PO₄)₃ (NVP). The structure of NVP is shown in FIG. 2. NVP is one of the most promising polyanionic cathode materials, showing attractive specific energy density and structural stability upon cycling. However, the main drawbacks of NVP are the poor electric conductivity and high kinetic barrier for Na diffusion resulting in unsatisfactory specific capability, poor cycling stability and rate performance.

In one example, the NVP is Zn-doped Na₃V₂(PO₄)₃. In another example, the NVP is pristine Na₃V₂(PO₄)₃. Zn-doped NVP is one of the best cathode materials for Na-ion battery, demonstrating improved storage performance and rate performance, and reduced internal resistance. In these examples, the Zn-doped NVP where Zn is substituted in the vanadium site comprises about 0.01-0.25 mol Zn.

In another example, the polyanion is Na₃₊ₓV₂₋ₓMnₓ(PO₄)₃ (0≤x≤1). In another example, the polyanion is Na₄VMn(PO₄)₃ (NVMP). Research show that manganese substitution in NASICON-type Na₃₊ₓV₂₋ₓMnₓ(PO₄)₃ (0≤x≤1) materials increases their average charge and discharge potential, rate capability and capacity. Replacement of smaller V³⁺ cations with larger Mn²⁺ enhances the sodium content and increases the unit cell volume. Similar to Na₃V₂(PO₄)₃ (NVP), slightly more than two Na⁺ ions can be extracted from Na₄VMn(PO₄)₃ (NVMP) upon charge above 3.8 V. That is further Na⁺ extraction from NVMP is realized through the V⁵⁺/V⁴⁺ redox at 3.9 V, which enhances both voltage and capacity analogous to NVP. Moreover, the presence of Mn in the cation sub-lattice alters the phase transformation behaviour and distribution of sodium cations over different positions at various stages of the charge-discharge cycle.

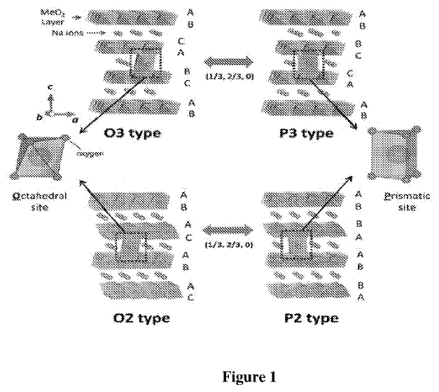

The composite cathode material as disclosed herein comprises a polyanion and a layered oxide. In one example, the layered oxide comprises the following elements—Na, Fe, Mn, Ni, Mg and O. In another example, the layered oxide is selected from the group consisting of O3/P3-NaₓM_{y}O_{z}, O3/P2-NaₓM_{y}O_{z}, O3-NaₓM_{y}O_{z}, P2-NaₓM_{y}O_{z}, and P3-NaₓM_{y}O_{z}; wherein x is ≥0.9, 0.8≤y≤1.0, and z is ≤2. Similar to their lithium analogues, sodium metal oxides exist as one of several polytypes. As used herein, “O3”, “P2” and “P3” refer to the types of structures of sodium metal oxides. Sodium metal oxides differ in the stacking of the close-packed oxygen layers, and are conventionally designated as O2 (ABAC stacking), O3 (ABCABC stacking), P2 (ABBA stacking), and P3 (ABBCCA stacking) by Delmas et al. [10](FIG. 1). The Na+ ions can be accommodated in different coordination environments, octahedral and prismatic (O=octahedral; P=prismatic) sites depending on the polytypes. The electrochemical behavior of layered oxides, in terms of long term cycling stability and energy density, is generally strongly affected by multiple phase transitions and voltage decay upon cycling. In addition, another issue associated with the use of layered oxides is their structural instability when exposed to air and especially to moisture.

As used herein, the terms “O3-type structure”, “O3-type phase” and “O3 phase” are seen as synonyms. Similarly, the terms “P2-type structure”, “P2-type phase” and “P2 phase” are seen as synonyms, and “P3-type structure”, “P3-type phase” and “P3 phase” are seen as synonyms.

In one example, the layered oxide is a single-phase layered oxide. In another example, the layered oxide is a biphasic layered oxide. In another example, the single-phase layered oxide has a single O3 phase, with the formula O3-NaₓM_{y}O_{z}, wherein x is ≥0.9, 0.8≤y≤1.0, and z is ≤2. In another example, the single-phase layered oxide has a single P2 phase, with the formula P2-NaₓM_{y}O_{z}, wherein x is ≥0.9, 0.8≤y≤1.0, and z is ≤2. In another example, the single-phase layered oxide has a single P3 phase, with the formula P3-NaₓM_{y}O_{z}, wherein x is ≥0.9, 0.8≤y≤1.0, and z is ≤2. In another example, the biphasic layered oxide has O3 and P3 phases, with the formula O3/P3-NaₓM_{y}O_{z}, wherein x is ≥0.9, 0.8≤y≤1.0, and z is ≤2. In another example, the biphasic layered oxide has P2 and O3 phases, with the formula O3/P2-NaₓM_{y}O_{z}, wherein x is ≥0.9, 0.8≤y≤1.0, and z is ≤2.

In one example, the layered oxide is O3/P3-NaₓM_{y}O_{z}, wherein x is ≥0.9, 0.8≤y≤1.0, and z is ≤2. The O3/P3 bi-phasic layered cathode material does not undergo any phase change upon cycling. Na-ions are coordinated in both octahedral (O3) and prismatic (P3) environments. In other words, the O3 and P3 bi-phases are maintained throughout the charge and discharge cycles. The primary issue with layered oxide materials is the irreversible and unwanted phase transformations that happen during cycling. This takes a serious toll on the stability of the material and cycle life and deters the commercialization of the material. The O3/P3 biphasic layered cathode material as disclosed herein solves the above mentioned issue, which is a major shortcoming in the commercialization of the layered oxide materials. In one example, the O3/P3-NaₓM_{y}O_{z} is O3/P3-NaₓFe_{y1}Mg_{y2}Mn_{y3}Ni_{y4}O_{z}, wherein x≥0.66; y2≤0.05; y4≤0.1; 0.9≤y1+y2+y3≤1.0; and z≤2. In another example, the O3/P3-NaₓM_{y}O_{z} is O3/P3-NaₓFe_{y1}Mg_{y2}Mn_{y3}Ni_{y4}O_{z}, wherein x is ≥0.9. In another example, the O3/P3-NaₓM_{y}O_{z} is O3/P3-NaₓFe_{y1}Mg_{y2}Mn_{y3}Ni_{y4}O_{z}, wherein x is 0.9. In another example, the O3/P3-NaₓM_{y}O_{z} is O3/P3-NaₓFe_{y1}Mg_{y2}Mn_{y3}Ni_{y4}O_{z}, wherein y1+y2+y3 is 1.0. In another example, the O3/P3-NaₓM_{y}O_{z} is O3/P3-NaₓFe_{y1}Mg_{y2}Mn_{y3}Ni_{y4}O_{z}, wherein z is 2. In another example, the O3/P3-NaₓM_{y}O_{z} is O3/P3-NaₓFe_{y1}Mg_{y2}Mn_{y3}Ni_{y4}O_{z} wherein x is 0.9, y1+y2+y3 is 1.0, and z is 2. In another example, the O3/P3 bi-phasic layered cathode material is O3/P3-Na_{0.9}Fe_{0.45}Mg_{0.05}Mn_{0.40}Ni_{0.1}O₂.

In one example, the layered oxide is O3/P3-Na_{0.9}Fe_{0.45}Mg_{0.05}Mn_{0.40}Ni_{0.1}O₂. In another example, the layered oxide is O3/P3 Na_{0.9}Fc_{0.5}Mn_{0.40}Ni_{0.1}O₂. In another example, the layered oxide is P3-Na_{0.9}Fe_{0.5}Mn_{0.5}O₂. In another example, the layered oxide is P2-Na_{0.7}Ni_{0.3}Mn_{0.59}Co_{0.1}Co_{0.01}O₂. In another example, the layered oxide is P2-Na_{0.67}Ni_{0.3}Mn_{0.6}Mg_{0.33}Ti_{0.067}O₂. In another example, the layered oxide is O3-Na_{0.9}Cu_{0.12}Ni_{0.1}Fe_{0.3}Mn_{0.43}Ti_{0.05}O₂.

In one example, in the formulas O3/P3-NaₓM_{y}O_{z}, O3/P2-NaₓM_{y}O_{z}, O3-NaₓM_{y}O_{z}, P2-NaₓM_{y}O_{z}, and P3-NaₓM_{y}O_{z} of the layered oxide as disclosed herein, M is a 3d-transition metal, a 4d-transition metal, a 3d/4d transition metal or combinations of these elements. In another example, M is a 3d-transition metal. In another example, M is a 4d-transition metal. In another example, M is a 3d/4d transition metal. In another example, M is a combination of a 3d-transition metal, a 4d-transition metal, and a 3d/4d transition metal. In another example, the 3d-transition metal is selected from the group consisting of Al³⁺, B³⁺, Ca²⁺, Mn⁺³, Mn⁺⁴, Mg⁺², Zn²⁺, Cu²⁺, Nb⁵⁺, Ti⁴⁺, Fe⁺³, and Ni⁺². In another example, the 4d-transition metal is selected from the group consisting of Al³⁺, B³⁺, Ca²⁺, Mn⁺³, Mn⁺⁴, Mg⁺², Zn²⁺, Cu²⁺, Nb⁵⁺, T⁴⁺, Fe⁺³, and Ni⁺². In another example, the 3d/4d transition metal is selected from the group consisting of Al³⁺, B³⁺, Ca²⁺, Mn⁺³, Mn⁺⁴, Mg⁺², Zn²⁺, Cu²⁺, Nb⁵⁺, Ti⁴⁺, Fe⁺³, and Ni⁺².

In one example, the oxidation state of M is between +1 to +7 depending on x, y and z. In another example, the oxidation state of M is +1. In another example, the oxidation state of M is +2. In another example, the oxidation state of M is +3. In another example, the oxidation state of M is +4. In another example, the oxidation state of M is +5. In another example, the oxidation state of M is +6. In another example, the oxidation state of M is +7.

In one example, the polyanion-layered oxide composite cathode material has a composition of (1-n) P2-NaₓM_{y}O_{z} and n NVP, where n is the weight percentage, 0<n<1, x is ≥0.9, 0.8≤y≤1.0, and z is ≤2. In another example, the polyanion-layered oxide composite cathode material has a composition of (1-n) P2-NaₓM_{y}O_{z} and n NVMP, where n is the weight percentage, 0<n<1, x is ≥0.9, 0.8≤y≤1.0, and z is ≤2. In another example, the polyanion-layered oxide composite cathode material has a composition of (1-n) O3-NaₓM_{y}O_{z} and n NVP, where n is the weight percentage, 0<n<1, x is ≥0.9, 0.8≤y≤1.0, and z is ≤2. In another example, the polyanion-layered oxide composite cathode material has a composition of (1-n) O3-NaₓM_{y}O_{z} and n NVMP, where n is the weight percentage, 0<n<1, x is ≥0.9, 0.8≤y≤1.0, and z is ≤2. In another example, the polyanion-layered oxide composite cathode material has a composition of (1-n) P3-NaₓM_{y}O_{z} and n NVP, where n is the weight percentage, 0<n<1, x is ≥0.9, 0.8≤y≤1.0, and z is ≤2. In another example, the polyanion-layered oxide composite cathode material has a composition of (1-n) P3-NaₓM_{y}O_{z} and n NVMP, where n is the weight percentage, 0<n<1, x is ≥0.9, 0.8≤y≤1.0, and z is ≤2. In another example, the polyanion-layered oxide composite cathode material has a composition of (1-n) O3/P2-NaₓM_{y}O_{z} and n NVP, where n is the weight percentage, 0<n<1, x is ≥0.9, 0.8≤y≤1.0, and z is ≤2. In another example, the polyanion-layered oxide composite cathode material has a composition of (1-n) O3/P2-NaₓM_{y}O_{z} and n NVMP, where n is the weight percentage, 0<n<1, x is ≥0.9, 0.8≤y≤1.0, and z is ≤2. In another example, the polyanion-layered oxide composite cathode material has a composition of (1-n) O3/P3-NaₓMₓO_{z} and n NVP, where n is the weight percentage, 0<n<1, x is ≥0.9, 0.8≤y≤1.0, and z is ≤2. In another example, the polyanion-layered oxide composite cathode material has a composition of and (1-n) O3/P3-NaₓM_{y}O_{z} and n NVMP, where n is the weight percentage, 0<n<1, x is ≥0.9, 0.8≤y≤1.0, and z is ≤2. In one example, n is 0.3. In another example, n is 0.5. In another example, n is 0.7.

In one example, the polyanion-layered oxide composite cathode material is 30% P2-NaₓM_{y}O_{z} and 70% NVP. In another example, the polyanion-layered oxide composite cathode material is 50% P2-NaₓM_{y}O_{z} and 50% NVP. In another example, the polyanion-layered oxide composite cathode material is 70% P2-NaₓM_{y}O_{z} and 30% NVP. In another example, the polyanion-layered oxide composite cathode material is 30% P2-NaₓM_{y}O_{z} and 70% NVMP. In another example, the polyanion-layered oxide composite cathode material is 50% P2-NaₓM_{y}O_{z} and 50% NVMP. In another example, the polyanion-layered oxide composite cathode material is 70% P2-NaₓM_{y}O_{z} and 30% NVMP. In the above formulations, x is ≥0.9, 0.8≤y≤1.0, and z is ≤2.

In another example, the polyanion-layered oxide composite cathode material is 30% O3-NaₓM_{y}O_{z} and 70% NVP. In another example, the polyanion-layered oxide composite cathode material is 50% O3-NaₓM_{y}O_{z} and 50% NVP. In another example, the polyanion-layered oxide composite cathode material is 70% O3-NaₓM_{y}O_{z} and 30% NVP. In another example, the polyanion-layered oxide composite cathode material is 30% O3-NaₓM_{y}O_{z} and 70% NVMP. In another example, the polyanion-layered oxide composite cathode material is 50% O3-NaₓM_{y}O_{z} and 50% NVMP. In another example, the polyanion-layered oxide composite cathode material is 70% O3-NaₓM_{y}O_{z} and 30% NVMP. In the above formulations, x is ≥0.9, 0.8≤y≤1.0, and z is ≤2.

In another example, the polyanion-layered oxide composite cathode material is 30% P3-NaₓM_{y}O_{z} and 70% NVP. In another example, the polyanion-layered oxide composite cathode material is 50% P3-NaₓM_{y}O_{z} and 50% NVP. In another example, the polyanion-layered oxide composite cathode material is 70% P3-NaₓM_{y}O_{z} and 30% NVP. In another example, the polyanion-layered oxide composite cathode material is 30% P3-NaₓM_{y}O_{z} and 70% NVMP. In another example, the polyanion-layered oxide composite cathode material is 50% P3-NaₓM_{y}O_{z} and 50% NVMP. In another example, the polyanion-layered oxide composite cathode material is 70% P3-NaₓM_{y}O_{z} and 30% NVMP. In the above formulations, x is ≥0.9, 0.8≤y≤1.0, and z is ≤2.

In another example, the polyanion-layered oxide composite cathode material is 30% O3/P2-NaₓM_{y}O_{z} and 70% NVP. In another example, the polyanion-layered oxide composite cathode material is 50% O3/P2-NaₓM_{y}O_{z} and 50% NVP. In another example, the polyanion-layered oxide composite cathode material is 70% O3/P2-NaₓM_{y}O_{z} and 30% NVP. In another example, the polyanion-layered oxide composite cathode material is 30% O3/P2-NaₓM_{y}O_{z} and 70% NVMP. In another example, the polyanion-layered oxide composite cathode material is 50% O3/P2-NaₓM_{y}O_{z} and 50% NVMP. In another example, the polyanion-layered oxide composite cathode material is 70% O3/P2-NaₓM_{y}O_{z} and 30% NVMP. In the above formulations, x is ≥0.9, 0.8≤y≤1.0, and z is ≤2.

In another example, the polyanion-layered oxide composite cathode material is 30% O3/P3-NaₓM_{y}O_{z} and 70% NVP. In another example, the polyanion-layered oxide composite cathode material is 50% O3/P3-NaₓM_{y}O_{z} and 50% NVP. In another example, the polyanion-layered oxide composite cathode material is 70% O3/P3-NaₓM_{y}O_{z} and 30% NVP. In another example, the polyanion-layered oxide composite cathode material is 30% O3/P3-NaₓM_{y}O_{z} and 70% NVMP. In another example, the polyanion-layered oxide composite cathode material is 50% O3/P3-NaₓM_{y}O_{z} and 50% NVMP. In another example, the polyanion-layered oxide composite cathode material is 70% O3/P3-NaₓM_{y}O_{z} and 30% NVMP. In the above formulations, x is ≥0.9, 0.8≤y≤1.0, and z is ≤2.

The polyanion-layered oxide composite cathode material as disclosed herein addresses the problems of the layered-oxide and polyanion each being used as cathodes alone, i.e. low thermal stability of layered oxides and low tap densities of polyanionic compounds. Since polyanionic compounds are thermally stable, the overall thermal stability of the composite significantly rises and from a safety point of view, this is a vital advantage of the polyanion-layered oxide composite cathode material as disclosed herein. In addition, polyanionic compounds typically suffer low tap densities. From an energy density perspective, the significantly increased tap densities of the polyanion-layered oxide composite cathode material as disclosed herein as compared to polyanionic compounds is another vital advantage.

The polyanion-layered oxide composite cathode material as disclosed herein demonstrates high thermal stability and superior electrochemical performances in selected optimized voltage windows in both half-cell and commercial type 18650 cells. In one example, the optimized voltage window in half-cell configuration is 4.0±0.5 V to 2.0±0.5 V. In another example, the optimized voltage windows in half-cell configuration is 4.0-2.5 V. In another example, the optimized voltage windows in a full cell, for example 18650 type commercial cells is 4.15-1.0V. In another example, the optimized voltage window in a full cell, for example 18650 type commercial cells is 4.3-1.5 V. In another example, the optimized voltage window in a full cell, for example 18650 type commercial cells is 4.25-2.5 V.

Most reported layered oxides suffer from poor rate performance and cycle life. By using the polyanion-layered oxide composite cathode material as disclosed herein, rate performance and cycle life are significantly enhanced as compared to layered oxide cathodes, due to better structural and thermal stabilities of the composite material. The polyanion-layered oxide composite cathode material as disclosed herein demonstrates better rate performance and cycle life of the cells as compared to layered oxide cathodes. In one example, the polyanion-layered oxide composite cathode material as disclosed herein retains at least 90% capacity after 500 cycles when cycled at IC (0.15 Ag⁻¹) when operated in an optimized voltage window 4.0-2.5 V. In another example, the polyanion-layered oxide composite cathode material as disclosed herein retains at least 93% capacity after 500 cycles when cycled at 1 C (0.15 Ag⁻¹) when operated in an optimized voltage window 4.0-2.5 V. In another example, the polyanion-layered oxide composite cathode material as disclosed herein retains at least 94% capacity after 500 cycles when cycled at 1 C (0.15 Ag⁻¹) when operated in an optimized voltage window 4.0-2.5 V. In another example, the polyanion-layered oxide composite cathode material as disclosed herein retains at least 95% capacity after 500 cycles when cycled at 1 C (0.15 Ag⁻¹) when operated in an optimized voltage window 4.0-2.5 V. In another example, the polyanion-layered oxide composite cathode material as disclosed herein retains at least 96% capacity after 500 cycles when cycled at 1 C (0.15 Ag⁻¹) when operated in an optimized voltage window 4.0-2.5 V. In another example, the polyanion-layered oxide composite cathode material as disclosed herein retains at least 97% capacity after 500 cycles when cycled at 1 C (0.15 Ag-t) when operated in an optimized voltage window 4.0-2.5 V. In another example, the polyanion-layered oxide composite cathode material as disclosed herein retains at least 98% capacity after 500 cycles when cycled at IC (0.15 Ag⁻¹) when operated in an optimized voltage window 4.0-2.5 V. In another example, the polyanion-layered oxide composite cathode material as disclosed herein retains at least 99% capacity after 500 cycles when cycled at 1 C (0.15 Ag⁻¹) when operated in an optimized voltage window 4.0-2.5 V. In another example, the polyanion-layered oxide composite cathode material as disclosed herein retains 100% capacity after 500 cycles when cycled at 1 C (0.15 Ag⁻¹) when operated in an optimized voltage window 4.0-2.5 V. In another example, at 3 C rate, the polyanion-layered oxide composite cathode material as disclosed herein retains 85% capacity of that obtained at C/10. In another example, the polyanion-layered oxide composite cathode material as disclosed herein retains 94% capacity after 100 cycles when cycled at 1 C (0.15 Ag⁻¹) when operated in an optimized voltage window of 4.0-2.5 V.

The polyanion-layered oxide composite cathode material as disclosed herein demonstrates high energy density compared to the layered oxides. In one example, the polyanion-layered oxide composite cathode material as disclosed herein has an energy density of 300-800 Wh/kg_{cathode}. In another example, the polyanion-layered oxide composite cathode material as disclosed herein has an energy density of about 300 Wh/kg_{cathode}. In another example, the polyanion-layered oxide composite cathode material as disclosed herein has an energy density of about 400 Wh/kg_{cathode}. In another example, the polyanion-layered oxide composite cathode material as disclosed herein has an energy density of about 500 Wh/kg_{cathode}. In another example, the polyanion-layered oxide composite cathode material as disclosed herein has an energy density of about 600 Wh/kg_{cathode}. In another example, the polyanion-layered oxide composite cathode material as disclosed herein has an energy density of about 700 Wh/kg_{cathode}. In another example, the polyanion-layered oxide composite cathode material as disclosed herein has an energy density of about 800 Wh/kg_{cathode}. In another example, the polyanion-layered oxide composite cathode material as disclosed herein has an energy density of 315-410 Wh/kg_{cathode}. In another example, the polyanion-layered oxide composite cathode material as disclosed herein has an energy density of 380-410 Wh/kg_{cathode}. In another example, the polyanion-layered oxide composite cathode material as disclosed herein has an energy density of about 315 Wh/kg_{cathode}. In another example, the polyanion-layered oxide composite cathode material as disclosed herein has an energy density of about 380 Wh/kg_{cathode}. In another example, the polyanion-layered oxide composite cathode material as disclosed herein has an energy density of about 410 Wh/kg_{cathode}.

In one example, the polyanion-layered oxide composite cathode material as disclosed herein has an energy density of 60-300 Wh/kg_{cell} in 18650 format. In another example, the polyanion-layered oxide composite cathode material as disclosed herein has an energy density of about 60 Wh/kg_{cell} in 18650 format. In another example, the polyanion-layered oxide composite cathode material as disclosed herein has an energy density of about 80 Wh/kg_{cell} in 18650 format. In another example, the polyanion-layered oxide composite cathode material as disclosed herein has an energy density of about 100 Wh/kg_{cell} in 18650 format. In another example, the polyanion-layered oxide composite cathode material as disclosed herein has an energy density of about 200 Wh/kg_{cell} in 18650 format. In another example, the polyanion-layered oxide composite cathode material as disclosed herein has an energy density of about 300 Wh/kg_{cell} in 18650 format. In another example, the polyanion-layered oxide composite cathode material as disclosed herein has an energy density of about 67 Wh/kg_{cell} in 18650 format. In another example, the polyanion-layered oxide composite cathode material 30% O3-NaₓM_{y}O_{z} and 70% NVP has an energy density of about 67 Wh/kg_{cell} in 18650 format with 8 g loading when cycled in the voltage window 4.15-1.0 V. In another example, the optimized voltage window in a full cell, for example 18650 type commercial cells is 4.3-1.5 V. In another example, the optimized voltage window in a full cell, for example 18650 type commercial cells is 4.25-2.5 V.

The polyanion-layered oxide composite cathode material as disclosed herein has a tap density that is higher than that of polyanionic compounds. In one example, the polyanion-layered oxide composite cathode material as disclosed herein has a tap density of 800-1500 mg/cm³. In another example, the polyanion-layered oxide composite cathode material as disclosed herein has a tap density of about 800 mg/cm³. In another example, the polyanion-layered oxide composite cathode material as disclosed herein has a tap density of about 900 mg/cm³. In another example, the polyanion-layered oxide composite cathode material as disclosed herein has a tap density of about 1000 mg/cm³. In another example, the polyanion-layered oxide composite cathode material as disclosed herein has a tap density of about 1100 mg/cm³. In another example, the polyanion-layered oxide composite cathode material as disclosed herein has a tap density of about 1200 mg/cm³. In another example, the polyanion-layered oxide composite cathode material as disclosed herein has a tap density of about 1300 mg/cm³. In another example, the polyanion-layered oxide composite cathode material as disclosed herein has a tap density of about 1400 mg/cm³. In another example, the polyanion-layered oxide composite cathode material as disclosed herein has a tap density of about 1500 mg/cm³. In another example, the polyanion-layered oxide composite cathode material as disclosed herein has a tap density of about 933 mg/cm³, about 832 mg/cm³, about 825 mg/cm³, about 1277 mg/cm³, or about 1012 mg/cm³. Different systems have different tap density. The higher the tap density, the better for improving the energy density for various applications.

The polyanion-layered oxide composite cathode material as disclosed herein also demonstrates lower internal resistance compared to the layered oxide cathodes, as well as better thermal stability and safety when compared to layered oxide cathodes for Na-ion cells.

The polyanion-layered oxide composite cathode material as disclosed herein for a sodium battery or sodium-ion battery can be used in rechargeable non-aqueous electrolyte-based batteries/cells. These sodium batteries or sodium-ion batteries can operate at ambient conditions as closed systems. Storage/sequestration of gases can be another application for these materials.

In another aspect, the polyanion-layered oxide composite cathode material as disclosed herein can be synthesized using a simple and inexpensive synthesis process. The method comprises any one of the following steps:
a) mixing a polyanion powder and a layered oxide powder to obtain a mixture, and coating the mixture on an Al foil; or
b) coating a layer of polyanion on an Al foil, then coating a layer of layered oxide on top of the polyanion layer; or
c) coating a layer of layered oxide on an Al foil, then coating a layer of polyanion on top of the layered oxide layer; or
d) coating polyanion and layered oxide in an alternating pattern on an Al foil.

In any of the above methods a)-d), the coating is done on both sides of the Al foil for a thickness of 50-250 μm.

For the poly anion-layered oxide composite cathode material as disclosed herein, the polyanion can be synthesized by a cheap soft template method while the oxide systems could be produced by a simple solid-state synthesis method.

In another aspect, the present disclosure refers to a sodium battery or sodium-ion battery comprising the polyanion-layered oxide composite cathode material as disclosed herein. Preferred use of the aforementioned polyanion-layered oxide composite cathode material as disclosed herein is in rechargeable non-aqueous electrolyte based batteries/cells. These batteries can operate at ambient conditions as closed systems. As used herein, “ambient conditions” refer to the prevailing air and surface temperature, relative humidity, and dew point in which the entire synthesis process is taking place. As used herein, “closed system” refers to a thermodynamic system in which transfer of matter between the system and surroundings does not take place, and only energy is transferred.

Storage/sequestration of gases is another application for the polyanion-layered oxide composite cathode material as disclosed herein. Further applications include energy storage applications for renewables, data storage center, lift systems in buildings, marine sector and electric vehicles.

As used in this application, the singular form “a,” “an,” and “the” include plural references unless the context clearly dictates otherwise. For example, the term “a metal” includes a plurality of metals, including mixtures and combinations thereof.

As used herein, the term “comprising” means “including.” Variations of the word “comprising”, such as “comprise” and “comprises,” have correspondingly varied meanings. Thus, for example, a composition “comprising” X may consist exclusively of X or may include one or more additional unrecited components.

As used herein, the term “about” in the context of concentration of a substance, size of a substance, length of time, or other stated values means+/−5% of the stated value, or +/−4% of the stated value, or +/−3% of the stated value, or +/−2% of the stated value, or +/−1% of the stated value, or +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Unless otherwise indicated, all technical and scientific terms used herein have the same meaning as commonly understood to one of ordinary skill in the art to which the invention belongs.

Other embodiments are within the following claims and non-limiting examples.

### Examples

Non-limiting examples of the disclosure will be further described in greater detail by reference to specific Examples, which should not be construed as in any way limiting the scope of the disclosure.

The disclosure relates to novel composite materials comprising layered oxide and polyanion that demonstrate high thermal stability and superior electrochemical performances in selected optimized voltage windows of both half-cell and commercial type 18650 cells, suitable to be used as cathode materials for a sodium battery or sodium-ion battery.

The polyanion-layered oxide composite cathode material refers to a composite of polyanion (Na₃V₂(PO₄)₃/Na₄VMn(PO₄)₃) and layered oxides comprising of the following elements—Na, Fe, Mn, Ni, Mg and O, to be used as cathode materials in sodium batteries/sodium-ion batteries. Proposed O3, P2, P3, O3/P2, and O3/P3 layered compounds refer to O3-NaₓM_{y}O_{z}, P2-NaₓM_{y}O_{z}, P3-NaₓM_{y}O_{z}, O3/P2-NaₓM_{y}O_{z}, and O3/P3-NaₓM_{y}O_{z}, with x≥0.9; 0.8≤y≤1.0 and z≤2. M can be any one of the 3d-transition metals, 4d-transition metals, or 3d/4d transition metals such as Mn^{+3/+4}, Mg⁺², Fe⁺³, Ni⁺², Al³⁺, B³⁺, Ca²⁺, Zn²⁺, Cu²⁺, Nb⁵⁺, Ti⁴⁺, or combinations of these elements. The oxidation state of M can be between +1 to +7 depending on x, y and z.

Referring to FIG. 1, Na ions are octahedrally coordinated in O3 and O2 structures while they lie in prismatic sites in the case of P3 and P2 structures.

FIG. 2 illustrates the structure of a polyanion Na₃V(PO₄)₃ (NVP) used in the present invention.

A list of possible embodiments of the polyanion-layered oxide composite cathode material as disclosed herein includes: (1-n) P2-NaₓM_{y}O_{z} and n NVP, or (1-n) P2-NaₓM_{y}O_{z} and n NVMP, where 0<n<1, wherein x is ≥0.9, 0.8≤y≤1.0, and z is ≤2; (1-n) O3-NaₓM_{y}O_{z} and n NVP, or (1-n) O3-NaₓM_{y}O_{z} and n NVMP, where 0<n<1, wherein x is ≥0.9, 0.8≤y≤1.0, and z is ≤2; (1-n) P3-NaₓM_{y}O_{z} and n NVP, or (1-n) P3-NaₓM_{y}O_{z} and n NVMP, where 0<n<1, wherein x is ≥0.9, 0.8≤y≤1.0, and z is ≤2; (1-n) O3/P2-NaₓM_{y}O_{z} and n NVP, or (1-n) O3/P2-NaₓM_{y}O_{z} and n NVMP, where 0<n<1, wherein x is ≥0.9, 0.8≤y≤1.0, and z is ≤2; (1-n) O3/P3-NaₓM_{y}O_{z} and n NVP, or (1-n) O3/P3-NaₓM_{y}O_{z} and n NVMP, where 0<n<1, wherein x is ≥0.9, 0.8≤y≤1.0, and z is ≤2.

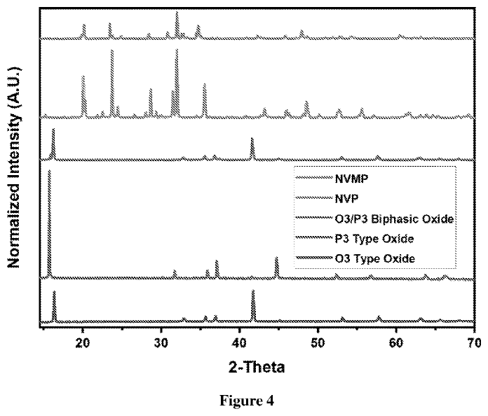

FIG. 4 shows the XRD plots of selected types of sodium based cathode materials as disclosed herein.

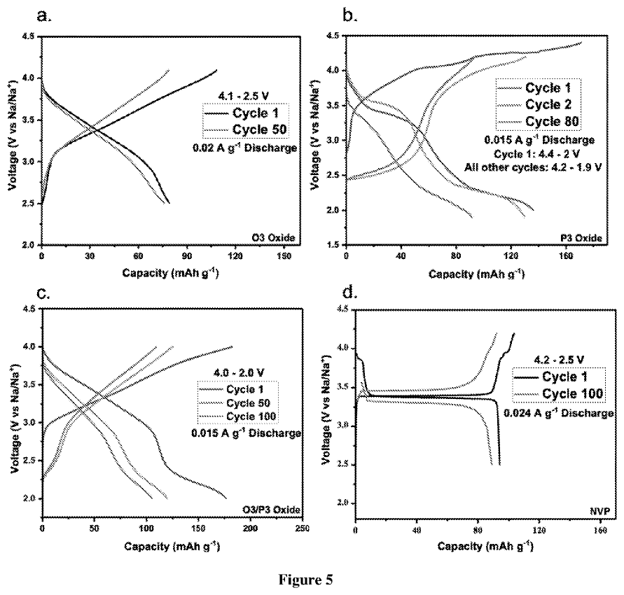

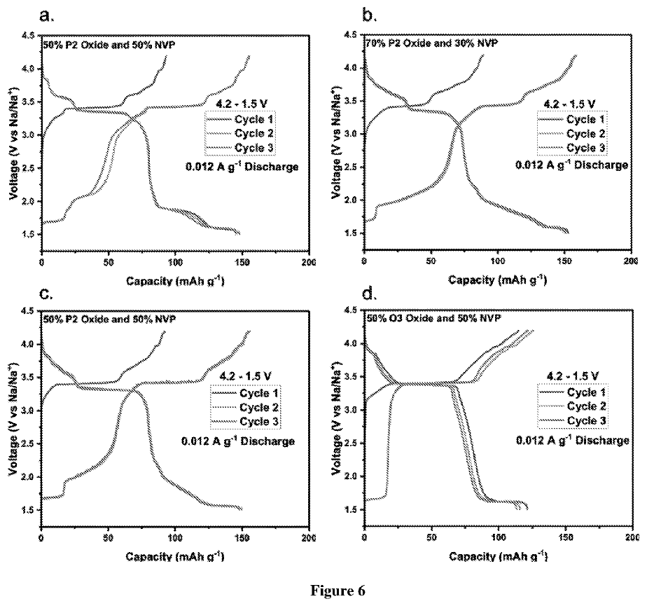

FIG. 5 illustrates the cycling performance of selected individual oxide-based and polyanion-based cathode materials in the half cell format.

### Better Rate Performance and Cycle Life of the Cells Using the Polyanion-Layered Oxide Composite Cathode Material as Disclosed Herein as Compared to Layered Oxide Cathodes

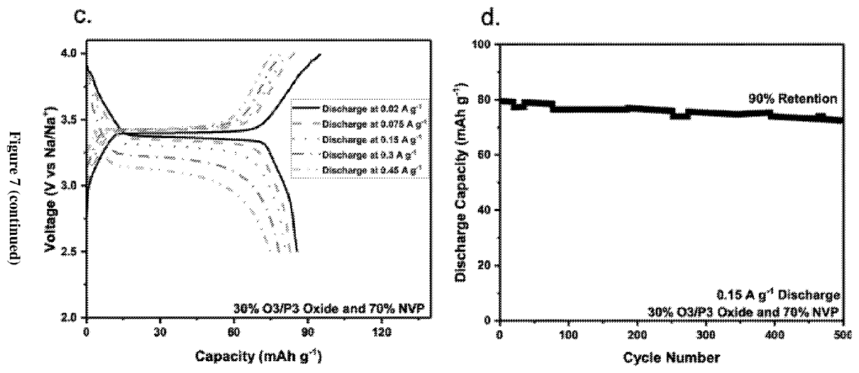

The disclosure includes multiple charge/discharge protocols both in full-cell (18650 type) and half-cell configurations in a sodium battery/sodium-ion battery with conventional anodes such as Hard Carbon, Na₂Ti₃O₇, Na₂Ti₆O₁₃, graphite, and alloy materials such as Sn, Sb, and so on. The optimized voltage window for full cell in the wide voltage was determined through testing of the polyanion-layered oxide composite cathode material with Na/Na⁺ in a half-cell format. Charge/discharge protocol in all voltage windows of the half-cell configuration (cathode v/s Na/Na+) is 4.0±0.5 V to 2.0±0.5 V. Using this protocol, charge, and discharge capacities of 80-160 mAhg⁻¹ were obtained in all the configurations when cycled at C/10 (0.01-0.015 Ag⁻¹). Energy densities in the range of 315-410 Wh/kg_{cathode} were obtained. The polyanion-layered oxide composite cathode material as disclosed herein, specifically a composite of 30% O3/P3 biphasic layered oxide and 70% NVP, also showed excellent cycle life with 90% capacity retention after 500 cycles at a high rate of 1 C (0.15 Ag⁻¹) for the voltage window 4.0-2.5V (FIG. 7d). This cycle life is higher than almost all the layered oxides reported to date. All cells have been cycled using either non-flammable 1M NaBF₄ in TGE electrolyte or carbonate based electrolyte such as 1M NaPF₆ in EC:DEC:DMC.

### High Energy Densities of the Polyanion-Layered Oxide Composite Cathode Material as Disclosed Herein

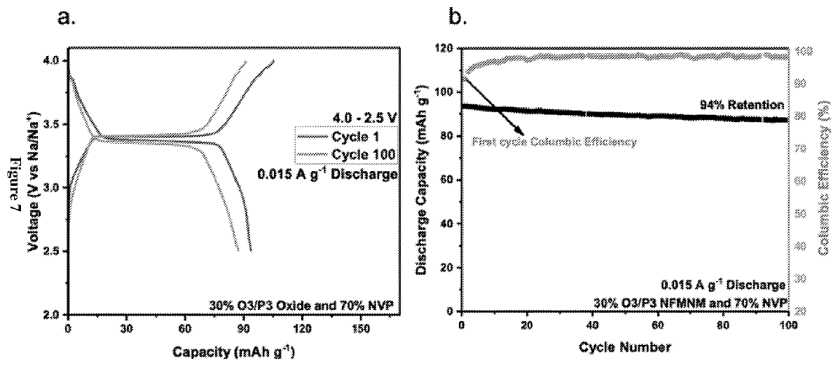

FIG. 6 shows cycling performances of composites of single phase layered oxides with NVP (FIG. 6a: 50% P2 oxide and 50% NVP, FIG. 6b: 70% P2 oxide and 30% NVP, FIG. 6c: 50% P2 oxide and 50% NVP, FIG. 6d: 50% O3 oxide and 50% NVP) cycled at C/10 (0.012 A g⁻¹) where energy densities between 380-410 Wh/kg_{cathode} were obtained. Tap densities were 825-1277 mg/cm³.

FIG. 7 shows cycling performances of composites of biphasic layered oxides and NVP. FIGS. 7a and 7b showed that 30% O3/P3 biphasic oxide and 70% NVP cycled at C/10 (0.015 A g⁻¹) exhibited an excellent capacity retention of 94% after 100 cycles. FIG. 7c showed the rate performance of 30% O3/P3 biphasic oxide and 70% NVP. FIG. 7d showed 30% O3/P3 biphasic oxide and 70% NVP having capacity retention of 90% after 500 cycles when cycled at 1 C (0.15 A g⁻¹). Tap density of the 30% O3/P3 biphasic oxide and 70% NVP composite is 1012 mg/cm³. This configuration demonstrated an energy density of 315 Wh/kg_{cathode}. Exceptional rate performance was also achieved. For instance, at 3 C rate, the discharge capacity was still 85% of the capacity obtained at C/10. Using these composite cathode materials, energy density in the range 300-800 Wh/kg_{cathode} can be achieved.

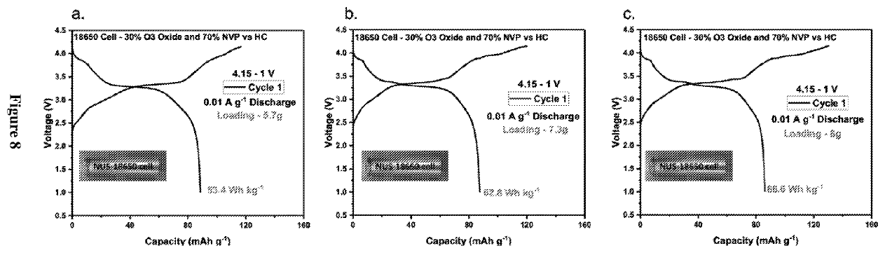

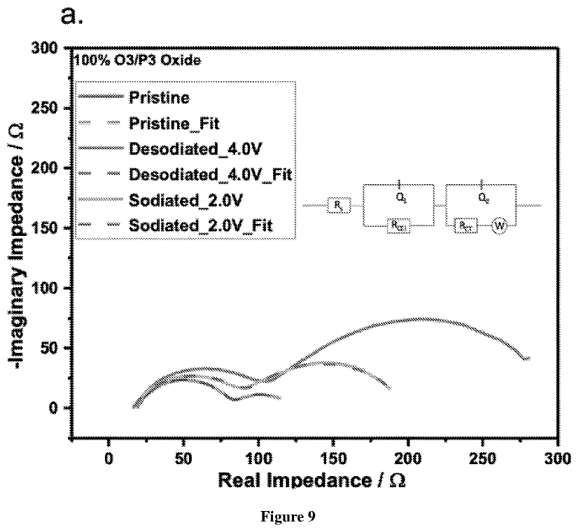

FIG. 8 showed 18650 type commercial cells of layered oxides and NVP versus Hard Carbon anode. 30% O3 oxide-70% NVP composite cathode material demonstrated high energy density of 67 Wh/kg_{cell} with 8 g loading when cycled at C/10 (0.01 A g⁻¹) in the voltage window 4.15-1.0V. Using the composite cathode material, energy density in the range 60-300 Wh/kg_{cell} in 18650 format can be achieved.

### Much Lower Internal Resistance in the Polyanion-Layered Oxide Composite Cathode Material

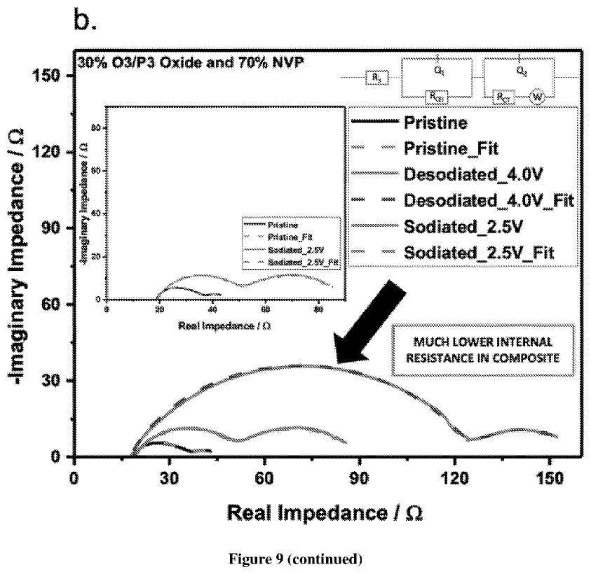

FIG. 9 showed a comparison of Electrochemical Impedance Spectroscopy (EIS) plots of a 100% O3/P3 layered oxide and a composite of layered oxide with NVP. FIG. 9 showed the result of impedance studies on selected polyanion-layered oxide composite cathode materials (30% O3/P3 oxide and 70% NVP). The results revealed significantly lower internal resistance specifically charge transfer resistance compared to 100% O3/P3 oxide, which helped in favourable storage performance.

Better Thermal Stability and Safety of the Polyanion-Layered Oxide Composite Cathode Material when Compared to Layered Oxide Cathodes for Na-Ion Cells.

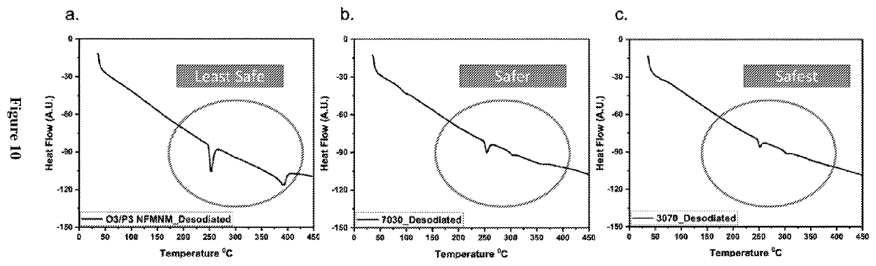

Further, using a composite cathode material significantly enhanced the overall thermal stability of the compound. From a safety point of view, this is extremely important. The enhanced thermal stability was confirmed using DSC studies on composite cathode materials. In FIG. 10, the composite cathode materials (70% O3/P3 oxide and 30% NVP in FIG. 10b, 30% O3/P3 oxide and 70% NVP in FIG. 10c) were shown to exhibit more thermal stability at higher temperatures and hence improved safety aspects than layered oxide cathodes (100% O3/P3 oxide in FIG. 10a).

Higher Tap Densities of the Polyanion-Layered Oxide Composite Cathode Material than Polyanionic Compounds

Tap densities of the polyanion-layered oxide composite cathode materials as disclosed herein were significantly enhanced when compared to polyanion compounds such as Na₃V₂(PO₄)₃. FIGS. 6 and 7 showed tap density values of the polyanion-layered oxide composite cathode materials as disclosed herein, which lie in the range of 800-1300 mg/cm³. As a comparison, the tap density of NVP is 950 mg/cm³ as shown in FIG. 5D.

The present invention solves the primary issue in layered oxides cathode materials—poor thermal stability and hence poor safety, which has deterred the commercialization process of the layered oxides. Layered oxides, however, have appreciable tap densities. Polyanionic compounds on the other hand are known to be very thermally stable but suffer from poor tap densities. This invention develops a polyanion-layered oxide composite cathode material, which has demonstrated better thermal stability than layered oxides, and improved tap densities when compared to polyanionic compounds. Using these polyanion-layered oxide composite cathode materials, high cycle life (>90%) and energy densities of 300-800 Wh/kg_{cathode} and 60-300 Wh/kg_{cell} in 18650 format can be achieved. Exceptional rate performance was also demonstrated. The polyanion-layered oxide composite cathode material of the present invention demonstrated better thermal stability, higher rate performance, longer cycle life, lower charge transfer resistance than layered oxide cathode materials, and also higher tap density than the polyanion based cathode materials. Further, the cost of polyanion cathode material is relatively high due to the vanadium component, this can be brought down by the composite cathode material as disclosed herein.

Comparison of Storage Performance of Zn-Doped Na₃V₂(PO₄)₃ Versus Pristine Na₃V₂(PO₄)₃

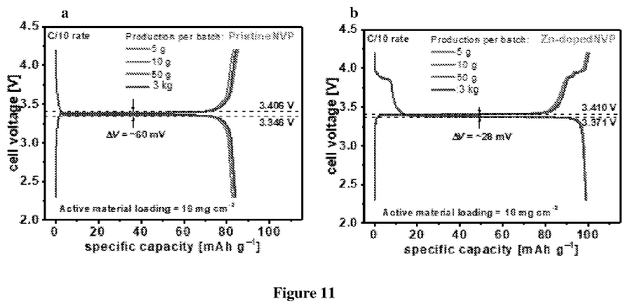

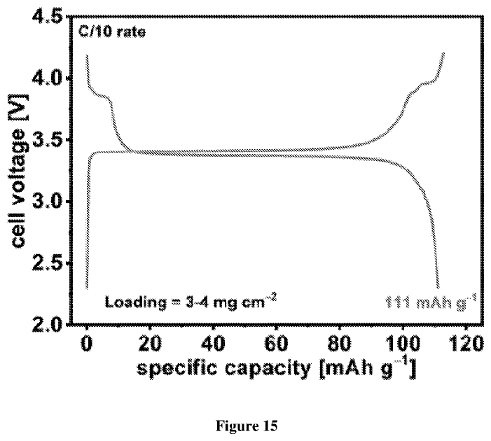

To investigate the influence of Zn substitution on electrochemical performance, both the pristine and modified NVP are assembled and tested in coin cells against Na metal. The modified NVP sample shows a Zn amount of 0.21 mol (Table 1). A Na:V:P stoichiometric molar ratio of 3:2:3 is obtained for the pristine NVP, which matches the chemical formula Na₃V₂(PO₄)₃. Data from elemental analysis validate the presence of 0.2 mol of Zn²⁺ per formula unit in the modified NVP sample, and results from Rietveld refinement confirm that this amount of Zn²⁺ are located in the V site. It is clear that the modified NVP performs better than the pristine NVP, achieving a discharge capacity of 99 mAh g⁻¹ compared to only 84 mAh g⁻¹ in the pristine NVP (FIG. 11) when cycled between 2.3 and 4.2 V (vs. Na) at C/10. Lower voltage polarisation (~28 mV) is achieved in the modified NVP. One may recognise that Na_{3.2}V_{1.8}Zn_{0.2}(PO₄)₃ has a theoretical capacity of 127 mAh g⁻¹ but only 99 mAh g⁻¹ was obtained. One possible explanation is that the active material loading in the modified NVP electrode being high (~10 mg cm⁻²) generally has its own inherent issues, e.g. poor electronic conductivity hence poor electronic wiring and poor electrolyte wettability. However, when the electrode contains less active material loading (3-4 mg cm⁻²), a storage capacity of 111 mAh g⁻¹ is achieved. (FIG. 15).

TABLE 1
Elemental composition of pristine
NVP and modified NVP samples.

| Sample | Na content | | V content | | Zn content | | P content | |
|---|---|---|---|---|---|---|---|---|
| Pristine NVP | 13.3 | wt % | 19.5 | wt % | n.d. | | 17.7 | wt % |
| | 3.01 | mol | 2.00 | mol | 0.00 | mol | 2.99 | mol |
| Modified NVP | 14.1 | wt % | 17.5 | wt % | 2.6 | wt % | 17.6 | wt % |
| | 3.21 | mol | 1.80 | mol | 0.21 | mol | 2.98 | mol |

All calculated molar ratios are normalised to the V content.

Another interesting observation observed from the voltage profile of the modified NVP in FIG. 11b is the appearance of a higher reversible voltage plateau at around 3.8 V during discharge (~3.9 V during charge). This is attributed to the reversible electrochemical activity of V⁴⁺/V⁵⁺ redox couple, where the extraction-insertion of Na+ occurs via a single phase mechanism. Such a high voltage plateau is absent in the pristine NVP (FIG. 11a). The presence of V⁴⁺→V⁵⁺ redox transition is shown systematically using ex-situ XPS.

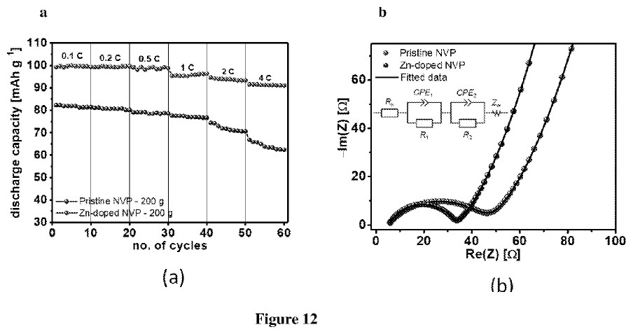

In terms of rate performance, the modified NVP displays distinct improvement of high C rate capability compared to the pristine sample (FIG. 12a). At a current rate of 4 C, the modified NVP retains a higher discharge capacity of 91 mAh g⁻¹ compared to pristine sample with only 67 mAh g⁻¹. It is believed that the observed high rate performance in the modified NVP is associated with lower internal resistance due to Zn doping resulting in superior Na chemical diffusion coefficient.

The Nyquist plot of the impedance spectra shown in FIG. 12b exhibits an apparent difference in the size of the depressed semicircle, where the modified NVP has a noticeably smaller size. By fitting the obtained impedance spectra with the equivalent circuit model shown in the inset to FIG. 12b, various resistances are obtained and summarised in Table 2. The values of the solution and contacts resistance (Rs), as well as passivation film resistance (R1) are almost identical between both pristine and modified NVP. However, the value of the charge transfer resistance (R2) computed for the modified NVP (20.6Ω) is two times lower than that of the pristine NVP (41.2Ω), implying an enhanced charge transfer at various electrode/electrolyte interfaces in the modified NVP material.

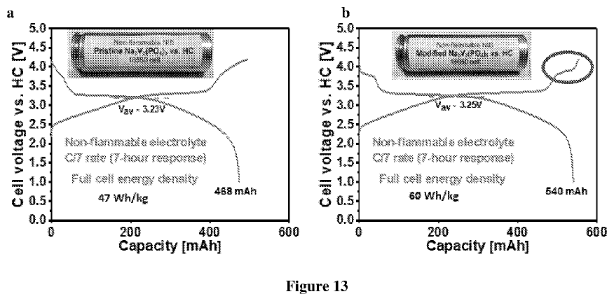

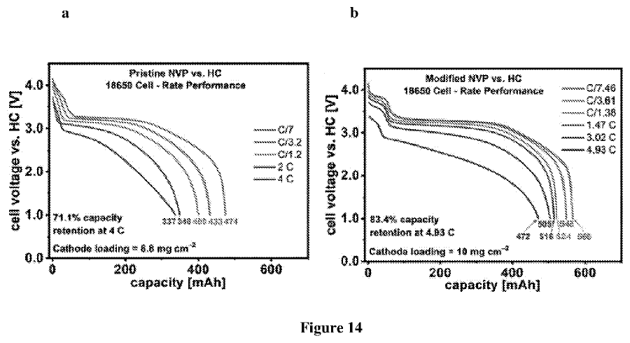

When the full cell is scaled up to 18650 format, similar voltage profiles are observed for both the pristine and modified NVP vs. HC as compared to those shown for coin cells. Do note that the voltage profile presented here is the second cycle; the first cycle, being the formation cycle, is not shown. The energy density of these 18650 cells are calculated taking into account the complete cell weight. It is found that the modified NVP vs. HC exhibits higher energy density of 60 Wh kg⁻¹ (FIG. 13a) compared to the pristine NVP vs. HC cells, which is only 47 Wh kg⁻¹ (FIG. 13b). Besides the higher discharge capacity acquired, the difference in energy density in both the 18650 cells is also attributed to the maximum obtainable electrode active material loading (5.8 g in pristine NVP vs. 6.5 g in modified NVP) in both the cathodes. When the pristine NVP loading on the aluminium foil is increased beyond 5.8 g, the coating integrity drops considerably, rendering the electrode unusable. In sharp contrast, a loading of 6.5 g is achievable in the modified NVP coating, while still maintaining good coating quality. The difference in achievable active cathode material loading is believed to originate from the tap density of the respective NVP samples. A higher tap density measured for the modified NVP results in better electrode packing, and this plays a crucial role in producing good quality electrodes with high active material loading. Both the 18650-type cells fabricated are tested for rate performance, and the resultant discharge profiles at various current rates are presented in FIG. 14a and FIG. 14b for pristine and modified NVP, respectively. The pristine NVP vs. HC delivers a discharge capacity of 474 mAh at a low rate C/7 and 71.1% of this capacity is retained at a high rate 4 C. On the other hand, the modified NVP vs. HC cell shows better storage performance delivering a discharge capacity of 566 mAh at a low rate C/7.46. Further, 83.4% of this discharge capacity is retained at a high rate close to 5 C, achieving 472 mAh. In this rate performance test, the current rate presented is based on the total time taken for the cell to reach a fully discharged state. For a clearer explanation, a current rate of 4.93 C in FIG. 14b means that the cell takes 12.2 min to be fully discharged. To access the durability of the modified NVP vs. HC cell, a long-term cycling test is conducted at a rate of C/5 for both charge and discharge.

As can be seen, Zn-doped NVP is one of the best cathode materials for Na-ion battery. Doping a few percentage of Zinc in the place of Vanadium helps in improving the storage performance and rate performance (see FIGS. 11 and 12) as compared to undoped NVP. Zinc doping also helps to reduce internal resistance of this cathode material, for example charge transfer resistance is reduced to half its value and Na diffusion coefficient is improved by one order of magnitude as shown in FIG. 11 and Table 2 below. The figure also displays the difference of storage performance for different scale of production from 5 g to 3 kg.

TABLE 2
Comparison of Charge Transfer Resistance (R2) and Na diffusion
co-efficient D_{Na} in Zn-doped NVP against pristine NVP

| Sample | Rₛ [Ω] | R₁ [Ω] | R₂ [Ω] | D_{Na} [×10⁻¹⁶ cm² s⁻¹] |
|---|---|---|---|---|
| Pristine NVP | 4.73 | 9.41 | 41.2 | 2.93 |
| Modified NVP | 5.45 | 8.14 | 20.6 | 19.2 |

Comparison of storage performance and rate performance 18650 cells made using pristine NVP and Zn doped NVP is shown in FIG. 13. Zn doped NVP cells provides high storage capacity (540 mAh) and higher energy density (60 Wh/kg) than the cell made using pristine NVP.

FIG. 14 (a) and (b) presents storage capacity and the resultant discharge profiles at various current rates for 18650-type cells fabricated using pristine and Zn-doped NVP, respectively. Zn doped NVP based 18650 cell shows much improved rate performance than the cell made using pristine NVP.

With Zn being successfully substituted in the modified NVP sample, as confirmed by ICP elemental analysis and XRD Rietveld analysis, Na storage properties are significantly improved. The enhanced discharge capacity in the modified NVP is due to the extra Na present, causing the activation of V⁴⁺ [symbol] V⁵⁺ redox couple. The presence of V⁴⁺ [symbol] V⁵⁺ redox activity during sodiation/desodiation is substantiated by XPS analysis, resulting in the emergence of a higher voltage plateau seen in the cell voltage profile of the modified NVP. In addition, the charge transfer resistance decreases in the Zn doped NVP, thus enhancing the Na chemical diffusion coefficient. This observation gives rise to a considerable improvement in high rate performance, as well as long cycle life (90% capacity retention after 200 cycles) in 18650 cell format. Moreover, the 18650 cell with modified NVP cathode delivers a discharge capacity of 566 mAh, resulting in an energy density of 60 Wh kg⁻¹. At a discharge rate close to 5 C, the modified NVP can still deliver a high capacity of 472 mAh. Present studies open opportunities for the deployment of these commercial-type Na-ion cells in large-scale EES systems considering their safety, storage performance and potential low-cost production.

### Experimental Methods

Electrochemical Impedance Spectroscopy (EIS) measurements were performed using Novocontrol Alpha-A High Performance Frequency Analyzer with frequency range of 100 kHZ to 1 Hz with applied AC signal of 100 mV on the samples.

For electrode preparation, active materials and carbon additives (Carbon Black Super P, Alfa Aesar; 99+%) were pre-mixed together and for the slurry preparation, binder solution of polyvinylidene fluoride (PVDF, Kynar 2801) dissolved in N-Methyl-2-pyrrolidone (NMP, Merck) were used. The ratio of active material to binder to carbon additive were 80:10:10. The pre-mixed powder was dissolved in binder solution was then stirred for 4 h at 1200 rpm. This slurry solution was then pasted on an Al current collector. The coated electrode was then dried for 18 h at 120° C. in a vacuum oven (Memmert, Germany). The dried electrode was roll pressed using a twin roller to ensure good contact between the current collector and electrode material. The pressed electrode was later stored in vacuum oven set at 120° C. The active material loading for half cells in the electrode was 2-3 mg cm⁻² and 6-8 mg cm⁻² for full cells. Prior to fabrication of 2016-type (MTI Corporation) coin cells in the Ar-filled glove box (MBraun, Germany; H2O and O2<1 ppm), both O3/P3 NFNM and O3/P3 NFMNM electrodes were punched from the single-side coated electrode into circular discs with a geometrical area of 2 cm² and dried once more in the glovebox antechamber at 120° C. for 3 h under vacuum. Both electrodes were utilized as working electrodes with the counter electrode being Na metal (Merck Millipore) and Hard Carbon for full cells. Glass fibre (Whatman, Grade GF/A) as separator was dried and used between the working electrode and the counter electrode.

Powder XRD was documented using Bruker Advance D8 which uses Cu-Kα radiation (Voltage=40 kV and Current=40 mA) between a 2θ range of 10-70°. Rietveld refinement was performed using TOPAS V6.

DSC was performed using a TA instrument 2920 to analyse the thermal stability of layered oxide-polyanion composite cathode materials.

### Synthesis Procedure

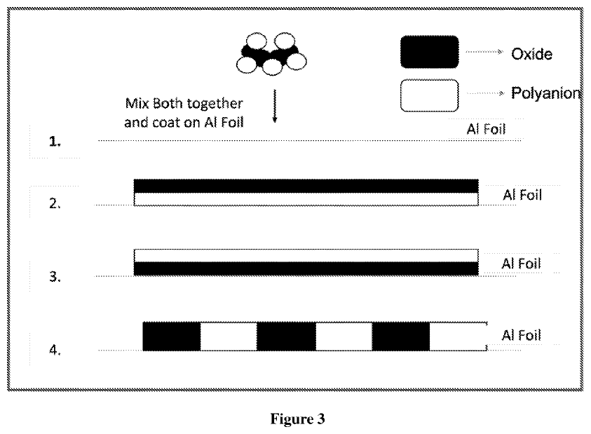

The polyanion-layered oxide composite cathode material as disclosed herein can be synthesized using four different methods as illustrated in FIG. 3. In method 1, the polyanion and layered oxide powders were physically mixed together first and then the composite slurry was coated on an Al foil for a defined thickness. Method 2 includes coating of a layer of polyanion slurry on an Al foil first, followed by coating a layer of oxide slurry on top of it. Method 3 includes coating a layer of oxide slurry on an Al foil first, followed by coating a layer of polyanion slurry on top of it. Method 4 includes coatings of both the oxide and polyanion slurries on the Al foil in an alternating pattern. In all the four methods, the composite slurry was coated on both sides of Al foil, for a thickness ranging from 50-250 μm on each side.

In these methods described above, the active materials (polyanion-layered oxide composite) and carbon additives (Carbon Black Super P, Alfa Aesar; 99+%) were pre-mixed together. For slurry preparation, binder solution of polyvinylidene fluoride (PVDF, Kynar 2801) dissolved in N-Methyl-2-pyrrolidone (NMP, Merck) was used. The ratio of active polyanion-layered oxide composite material to Carbon additive to Binder was 80:10:10. The pre-mixed powder dissolved in binder solution was then stirred for 4 h at 1200 rpm and then pasted on an Al current collector with a thickness of 150 μm. The coated electrode was then dried for 18 h at 120° C. in a vacuum oven (Memmert, Germany). The dried electrode was roll pressed using a twin roller to ensure good contact between the current collector and electrode material. The pressed electrode was later stored in vacuum oven set at 120° C. In another method, about 75 μm of the polyanion slurry was applied to the Al collector. 75 μm of oxide slurry was then coated on the polyanion slurry. The drying process is the same as mentioned above.

### Coin Cell Fabrication

All HC and NVP electrodes are punched from the single-side coated electrode into circular discs with a geometrical area of 2.01 cm², and dried again in the antechamber at 120° C. for 2 h under vacuum prior to fabrication of 2016-type (MTI Corporation) coin cells in the Ar-filled glove box (MBraun, Germany; H₂O and O₂<5 ppm). The HC and NVP electrodes served as the working electrodes while Na metal (Merck Millipore) is used as the counter electrode. Between the working electrode and the counter electrode, a glass fibre (Whatman, Grade GF/A) is applied as the separator. In a split flat three-electrode setup (MTI Corporation), the counter electrode used is Na metal for half-cell and HC for full cell, respectively, with NVP as the working electrode. The Swagelok sized electrode used here has an area of 0.95 cm². Depending on the aim of the analysis, the electrolytes used in HC cells are either 1 M NaBF₄ in tetraglyme or 1 M NaClO₄ in EC:PC. Only 1 M NaBF₄ in tetraglyme was used as electrolyte in NVP full-cell. Both tetraglyme as well as carbonate electrolytes were used in half-cell.

### 18650-Type Cell Fabrication

In addition to the coin-type cell, NVP vs. HC 18650-type cell is also fabricated. The electrode fabrication and the cell assembly are carried out in a dry room under a controlled 1% humidity level. As-prepared double side coated electrodes are slit into the desired lengths and widths and then vacuum dried at 100° C. for 24 h. The cathode and anode electrodes are wound together with polypropylene separators (MTI Corporation) into cylindrical jellyroll and then dried at 100° C. overnight under vacuum before being sealed in 18650-cylindrical case with the electrolyte mentioned previously. The loading of the double-side coated cathodes and anodes are 16-20 mg cm⁻² and 8-10 mg cm⁻², respectively. The assembled batteries are kept at room temperature for about 24 h and cycled between 1.0 and 4.1 V at various current densities.

### INDUSTRIAL APPLICABILITY

Possible applications of the polyanion-layered oxide composite cathode material of the present invention include energy storage applications for renewables, data storage center, lift systems in buildings, marine sector and electric vehicles.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

### REFERENCES

[1] Renewables—Global Energy Review 2020—Analysis, 2020.
[2] Innovation in batteries and electricity storage—A global analysis based on patent data, September 2020.
[3] Palomares, V., Serras, P., Villaluenga, I., Hueso, K. B., Carretero-GonzAlez, J., Rojo, T., Na-ion batteries, recent advances and present challenges to become low cost energy storage systems. Energy Environ. Sci. 5(2012), 5884.
[4] Greim, P., Solomon, A. A., Breyer, C., Assessment of lithium criticality in the global energy transition and addressing policy gaps in transportation. Nat Commun 11 (2020), 4570.
[5] Conte, N., How Metals Prices Performed in 2021, Elements by Visual Capitalist, 2022.
[6] Vaalma, C., Buchholz, D., Weil, M., Passerini, S., A cost and resource analysis of sodium-ion batteries. Nat Rev Mater 3 (2018), 18013.
[7] Delmas, C., Sodium and Sodium-Ion Batteries: 50 Years of Research. Advanced Energy Materials 8 (2018). 1703137.
[8] Ong, S. P., Chevrier, V. L., Hautier, G., Jain, A., Moore, C., Kim, S., Ma, X., Ceder, G., Voltage, stability and diffusion barrier differences between sodium-ion and lithium-ion intercalation materials. Energy Environ. Sci. 4 (2011), 3680.9.S. Komaba, N. Yabuuchi, T. Nakayama, A. Ogata, T. Ishikawa and I. Nakai, Inorganic Chemistry, 2012, 51, 6211-6220.
[9] Ramesh, A., Tripathi, A., Bosman, M., Xi, S., Balaya. P., 2023. Enhancement in rate performance and high voltage structural stability of P3/O3 Na_{0.9}Fe0.5Mn0.45Ni_{0.05}O₂ layered oxide cathode. Journal of Electroanalytical Chemistry 932, 117222.
[10] Delmas, C., Fouassier, C., Hagenmuller, P., Structural classification and properties of the layered oxides. Physica B+C 99 (1980), 81-85.
[11] Wang, Q.-C., Meng, J.-K., Yue, X.-Y., Qiu, Q.-Q., Song, Y., Wu, X.-J., Fu, Z.-W., Xia, Y.-Y., Shadike, Z., Wu, J., Yang, X.-Q. Zhou. Y.-N., Tuning P2-Structured Cathode Material by Na-Site Mg Substitution for Na-Ion Batteries. J. Am. Chem. Soc. 141 (2019), 840-848.
[12] Wang, P.-F., You, Y., Yin, Y.-X., Guo, Y.-G., 2018. Layered Oxide Cathodes for Sodium-Ion Batteries: Phase Transition, Air Stability, and Performance. Adv. Energy Mater. 8, 1701912.
[13]L. Mu, S. Xu, Y. Li, Y.-S. Hu, H. Li, L. Chen and X. Huang, Advanced Materials (2015), 27, 6928-6933.
[14] Ramesh, A., Tripathi, A., Balaya, P., 2022. A mini review on cathode materials for sodium-ion batteries. Int J Applied Ceramic Tech 19, 913-923. [14] Ramesh, A., Tripathi, A., Balaya, P., 2022. A mini review on cathode materials for sodium-ion batteries. Int J Applied Ceramic Tech 19, 913-923.
[15] Chen, S., Wu, C., Shen, L., Zhu, C., Huang, Y., Xi, K., Maier, J., Yu, Y., 2017. Challenges and Perspectives for NASICON-Type Electrode Materials for Advanced Sodium-Ion Batteries. Advanced Materials 29, 1700431.
[16] Camacho, P. S., Wernert, R., Duttine, M., Wattiaux, A., Rudola, A., Balaya, P., Fauth, F., Berthelot, R., Monconduit, L., Carlier, D., Croguennec, L., 2021. Impact of Synthesis Conditions in Na-Rich Prussian Blue Analogues. ACS Appl. Mater. Interfaces 13, 42682-42692.
[17] Du, K., Wang, C., Subasinghe, L. U., Gajella, S. R., Law, M., Rudola, A., Balaya, P., 2020. A comprehensive study on the electrolyte, anode and cathode for developing commercial type non-flammable sodium-ion battery. Energy Storage Materials 29, 287-299.
[18] Morales, D., Chagas, L. G., Paterno, D., Greenbaum, S., Passerini, S., Suarez, S., 2021. Transport studies of NaPF6 carbonate solvents-based sodium ion electrolytes. Electrochimica Acta 377, 138062.
[19] Kulova, T. L., Skundin, A. M., 2022. Electrode/Electrolyte Interphases of Sodium-Ion Batteries. Energies 15, 8615.
[20] Ould, D. M. C., Menkin, S., O' Keefe, C. A., Coowar, F., Barker, J., Grey, C. P., Wright, D. S., 2021. New Route to Battery Grade NaPF 6 for Na-Ion Batteries: Expanding the Accessible Concentration. Angew. Chem. Int. Ed. 60, 24882-24887.
[21] Al-Salih, H., Houache, M. S. E., Baranova, E. A., Abu-Lebdeh, Y., 2022. Composite Cathodes for Solid-State Lithium-Batteries: “Catholytes” the Underrated Giants. Adv Energy and Sustain Res 3. 2200032.

1. A polyanion-layered oxide composite cathode material for a sodium battery or sodium-ion battery, the material comprising a polyanion and a layered oxide,
wherein the polyanion is Na₃V₂(PO₄)₃ (NVP) or Na₄VMn(PO₄)₃ (NVMP);
wherein the layered oxide is selected from the group consisting of O3/P3-NaₓM_{y}O_{z}, O3/P2-NaₓM_{y}O_{z}, O3-NaₓM_{y}O_{z}, P2-NaₓM_{y}O_{z}, and P3-NaₓM_{y}O_{z}; and
wherein x is ≥0.9, 0.8≤y≤1.0, and z is ≤2.

2. The polyanion-layered oxide composite cathode material of claim 1, wherein M is selected from the group consisting of a 3d-transition metal, a 4d-transition metal, and a 3d/4d transition metal.

3. The polyanion-layered oxide composite cathode material of claim 2, wherein the 3d/4d transition metal is selected from the group consisting of Al³⁺, B³⁺, Ca²⁺, Mn⁺³, Mn⁺⁴, Mg⁺², Zn²⁺, Cu²⁺, Nb⁵⁺, Ti⁴⁺, Fe⁺³, and Ni⁺².

4. The polyanion-layered oxide composite cathode material of claim 1, wherein the oxidation state of M is between +1 and +7.

5. The polyanion-layered oxide composite cathode material of claim 1, wherein the Na₃V₂(PO₄)₃ (NVP) is Zn-doped Na₃V₂(PO₄)₃.

6. The polyanion-layered oxide composite cathode material of claim 1, wherein the polyanion-layered oxide composite cathode material has a composition selected from the group consisting of
(1-n) P2-NaₓM_{y}O_{z} and n NVP, (1-n) P2-NaₓM_{y}O_{z} and n NVMP, (1-n) O3-NaₓM_{y}O_{z} and n NVP, (1-n) O3-NaₓM_{y}O_{z} and n NVMP, (1-n) P3-NaₓM_{y}O_{z} and n NVP, (1-n) P3-NaₓM_{y}O_{z} and n NVMP, (1-n) O3/P2-NaₓM_{y}O_{z} and n NVP, (1-n) O3/P2-NaₓM_{y}O_{z} and n NVMP, (1-n) O3/P3-NaₓM_{y}O_{z} and n NVP, and (1-n) O3/P3-NaₓM_{y}O_{z} and n NVMP;
where n is the weight percentage, 0<n<1, x is ≥0.9, 0.8≤y≤1.0, and z is ≤2.

7. The polyanion-layered oxide composite cathode material of claim 6, wherein n is selected from the group consisting of 0.3, 0.5 and 0.7.

8. The polyanion-layered oxide composite cathode material of claim 6, wherein the polyanion-layered oxide composite cathode material is 30% O3/P3-NaₓM_{y}O_{z} and 70% NVP.

9. The polyanion-layered oxide composite cathode material of claim 1, wherein the material retains 90% capacity after 500 cycles when cycled at 1 C (0.15 Ag⁻¹) when operated in an optimized voltage window.

10. The polyanion-layered oxide composite cathode material of claim 9, wherein the optimized voltage window is 4.3-1.5V.

11. The polyanion-layered oxide composite cathode material of claim 9, wherein the optimized voltage window is 4.0-2.5V.

12. The polyanion-layered oxide composite cathode material of claim 1, wherein the material has an energy density of 300-800 Wh/kg_{cathode} and 60-300 Wh/kg_{cell} in 18650 format.

13. The polyanion-layered oxide composite cathode material of claim 1, wherein the material has a tap density of 800-1500 mg/cm³.

14. A method of synthesizing the polyanion-layered oxide composite cathode material of claim 1, wherein the method comprises any one of the following steps:
a) mixing a polyanion powder and a layered oxide powder to obtain a mixture, and coating the mixture on an Al foil; or
b) coating a layer of polyanion on an Al foil, then coating a layer of layered oxide on top of the polyanion layer; or
c) coating a layer of layered oxide on an Al foil, then coating a layer of polyanion on top of the layered oxide layer; or
d) coating polyanion and layered oxide in an alternating pattern on the Al foil;
wherein in any of a)-d), the coating is done on both sides of the Al foil for a thickness of 50-250 μm.

15. A sodium battery or sodium-ion battery comprising the polyanion-layered oxide composite cathode material of claim 1.

16. The sodium battery or sodium-ion battery of claim 15, wherein the sodium battery or sodium-ion battery is a rechargeable non-aqueous electrolyte based battery.

17. The sodium battery or sodium-ion battery of claim 15, wherein the sodium battery or sodium-ion battery operates at ambient conditions as closed systems.
